(19) United States
(12) Patent Application Publication
(10) Pub. No.: US 2025/0144510 A1
(43) Pub. Date: May 8, 2025

(54) Tracking system and device integrating existing positional tracking system and docking mechanism

(71) Applicant: National Central University, Taoyuan City (TW)

(72) Inventors: Chih-Yuan Huang, Taoyuan City (TW); Jheng-Ruei Yu, Kaohsiung City (TW); Yi-Zhi Guo, Chiayi City (TW); Hung-Chieh Huang, Yunlin County (TW)

(21) Appl. No.: 18/413,688

(22) Filed: Jan. 16, 2024

(30) Foreign Application Priority Data
Nov. 3, 2023 (TW) 112142540

(51) Int. Cl. A63F 13/212; A63F 13/211; G06F 3/01; G06F 3/0346; G06F 3/038

(52) U.S. Cl. CPC A63F 13/212; A63F 13/211; G06F 3/014; G06F 3/0346; G06F 3/0383; G06F 2203/0331

(57) ABSTRACT

A tracking system and a device integrating an existing positional tracking system and a docking mechanism include a tracking system hardware module, a docking mechanism, and a positional tracking software module and are adapted to capture a user's finger movement and send in real time and synchronously the user's finger movement to a computer. The docking mechanism is compatible with an existing third-party positional tracking system such that the device can operate in conjunction with existing, commercially-available positional tracking systems, for example, HTC VIVE Tracker, and Oculus Quest, and thus is applicable to an existing game engine.

### FIELD OF THE INVENTION

The present disclosure relates to a tracking system and a device integrating an existing positional tracking system and a docking mechanism, particularly to ones functioning as a game engine-related support tool, and more particularly to ones capable of capturing and synchronously sending a user's hand gesture and hand absolute posture data to a computer.

### DESCRIPTION OF THE PRIOR ART

From the perspective of the operation of a human-computer interaction interface system and haptic feedback therefrom, existing commercially-available human-computer interaction interface systems fall into two operational categories: handheld controller interaction and glove-type controller interaction. Regarding the handheld controller interaction, a user interacts with a computer by manipulating buttons and a joystick of a handheld controller. However, the handheld controller interaction has some drawbacks. Throughout the course of usage, the user has to hold an additional controller by hand and learn how to use the controller to perform interaction. Furthermore, the haptic feedback given by the controller is simple and restricted to vibration. As a result, the aforesaid operation and feedback is unsatisfactory in terms of the immersiveness and intuitiveness in the course of operation. Regarding the glove-type controller interaction, a user's hand position and hand gesture are recognized with sensors on a glove or specific marked points on the glove operating in conjunction with an external apparatus. The glove-type controller interaction enables the user to directly interact with a computer by hand and by hand gesture and thus is satisfactory in terms of the intuitiveness in the course of operation. Furthermore, the glove-type controller can operate in conjunction with other mechanisms and actuation systems (such as an exoskeleton system, external tendon system, and vibration motor) to give real haptic feedback to the user.

Regarding the operation of existing glove-type controllers, the common, existing commercially-available solution to detection of a user's hand gesture with sensors on a glove involves estimating finger flexion angles and directions with a flex sensor and an inertial measurement unit. However, the flex sensor can only measure one degree of freedom for rotation and is susceptible to damage from persistent flexion. Furthermore, the sensor data of the inertial measurement unit drifts with time, leading to increasingly great measurement data errors associated with long use. As a result, the aforesaid conventional operation of the aforesaid sensor is unsatisfactory as far as positional tracking is concerned. The common, existing commercially-available solution to detection of a user's hand gesture with specific marked points on the glove operating in conjunction with an external apparatus involves tracking fingers' positions by means of optical positional tracking. However, optical positional tracking is disadvantaged by obstacle-induced hindrance of light propagation. The disadvantage can be overcome with the installation of cameras or by limiting the range of hand movement; however, the former incurs cost and is space-dependent, and the latter undermines the operation and user experience. As a result, the aforesaid technique is undesirable to wearable devices.

In view of the aforesaid drawbacks of the prior art, it is necessary to provide a solution to capturing the absolute posture of a user's fingers in actual space.

### BRIEF SUMMARY OF THE INVENTION

It is an objective of the disclosure to overcome the aforesaid drawbacks of the prior art and provide a tracking system and a device integrating an existing positional tracking system and a docking mechanism to capture a user's finger movement and send in real time and synchronously the user's finger movement to a computer. The docking mechanism is compatible with an existing third-party positional tracking system such that the device can operate in conjunction with existing, commercially-available positional tracking systems, for example, HTC VIVE Tracker, and Oculus Quest, and thus is applicable to an existing game engine.

To achieve the above and other objectives, the disclosure provides a tracking system and a device integrating an existing positional tracking system and a docking mechanism, comprising: a tracking system hardware module essentially having a signal emitter, multiple sensor modules and a system controller, the sensor modules being mounted on a user's fingertips and a dorsal side of the user's hand, wherein the signal emitter and the system controller are mounted on the dorsal side of the user's hand such that the signal emitter receives control signals from the system controller and generates known electromagnetic signals, and, when the user's fingers move relative to the signal emitter, the sensor modules mounted on the fingertips measure the electromagnetic signals generated by the signal emitter and output measurement signals thus obtained; a docking mechanism mounted on the dorsal side of the user's hand and adapted to dock with the existing positional tracking system; and a positional tracking software module forming the tracking system together with the tracking system hardware module and having a signal processing module connected to the sensor modules, a posture estimation module connected to the signal processing module, and a hand gesture estimation module connected to the posture estimation module, wherein the signal processing module receives the measurement signals from the sensor modules, performs signal processing on the measurement signals, and sends the processed measurement signals to the posture estimation module for calculating a posture of each of the sensor modules and a posture data of each of the user's fingers relative to the signal emitter such that the posture data is used by the hand gesture estimation module to estimate a flexion state of each joint of each of the user's fingers and the fingers' posture relative to the hand, wherein, with the docking mechanism operating in conjunction with an existing third-party positional tracking system, a posture relation between the existing third-party positional tracking system and the tracking system is established with a known geometric design parameter of the docking mechanism, and the absolute posture of the user's fingers in actual space is calculated according to the posture relation.

In the aforesaid embodiment of the disclosure, the docking mechanism is either a tracker docking mechanism or a handheld controller docking mechanism, depending on the existing positional tracking system.

### BRIEF DESCRIPTION OF THE DRAWINGS

FIG. 1 is a schematic view of the hardware configuration of the disclosure.

FIG. 2 is a schematic view of the hardware configuration of a docking mechanism operating in conjunction with existing positional tracking system I according to the disclosure.

FIG. 3 is a schematic view of the hardware configuration of the docking mechanism operating in conjunction with existing positional tracking system II according to the disclosure.

FIG. 4 is a block diagram of positional tracking software of the disclosure.

FIG. 5 is a schematic view of coordinate transformation of the device of the disclosure.

FIG. 6 is a schematic view of coordinate transformation of the device having a docking mechanism operating in conjunction with existing positional tracking system I according to the disclosure.

FIG. 7 is a schematic view of coordinate transformation of the device having the docking mechanism operating in conjunction with existing positional tracking system II according to the disclosure.

FIG. 8 is a schematic view of data transmission between the hardware and software module of the disclosure.

FIG. 9 is a schematic view of the process flow of system operation of the device of the disclosure.

### DESCRIPTION OF THE PREFERRED EMBODIMENTS

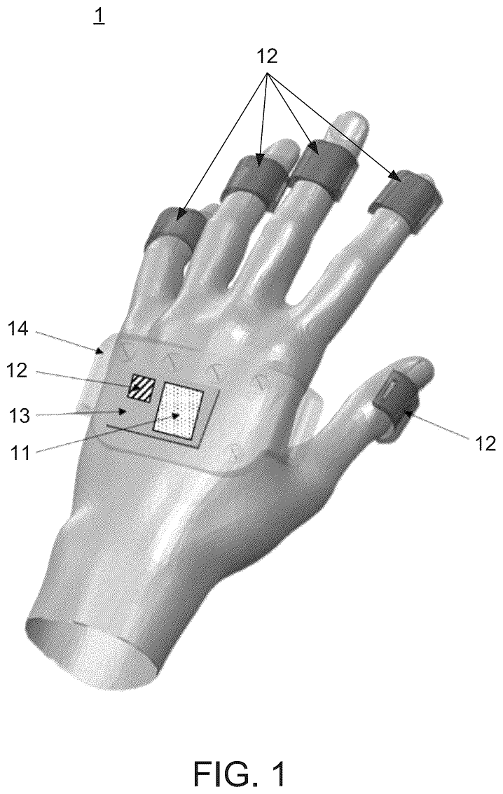

Referring to FIG. 1 through FIG. 9, there are shown a schematic view of the hardware configuration of the disclosure, a schematic view of the hardware configuration of a docking mechanism operating in conjunction with existing positional tracking system I according to the disclosure, a schematic view of the hardware configuration of the docking mechanism operating in conjunction with existing positional tracking system II according to the disclosure, a block diagram of positional tracking software of the disclosure, a schematic view of coordinate transformation of the device of the disclosure, a schematic view of coordinate transformation of the device having a docking mechanism operating in conjunction with existing positional tracking system I according to the disclosure, a schematic view of coordinate transformation of the device having the docking mechanism operating in conjunction with existing positional tracking system II according to the disclosure, a schematic view of data transmission between the hardware and software module of the disclosure, and a schematic view of the process flow of system operation of the device of the disclosure. As shown in the diagrams, the disclosure provides a tracking system and a device integrating an existing positional tracking system and a docking mechanism to capture and synchronously send the user's hand gesture and hand absolute posture data to a computer, comprising a tracking system hardware module 1, a docking mechanism 2, and a positional tracking software module 3.

As shown in FIG. 1, the tracking system hardware module 1 essentially has a signal emitter 11, multiple sensor modules 12 and a system controller 13. The sensor modules 12 are mounted on the user's fingertips and the dorsal side of the user's hand. The signal emitter 11 and the system controller 13 are mounted on the dorsal side of the user's hand through a platform 14.

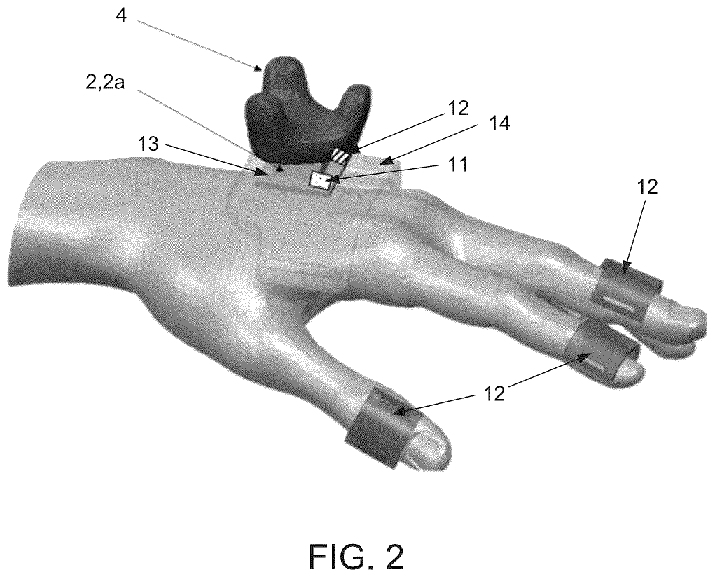

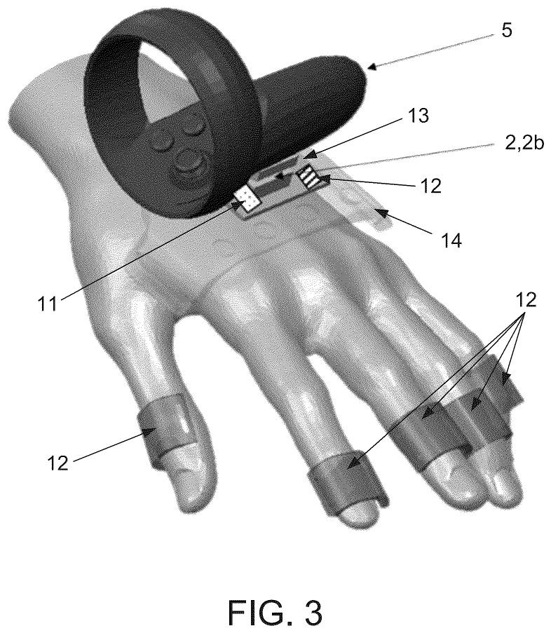

The docking mechanism 2 is mounted on the dorsal side of the user's hand through the platform 14, electrically connected to the system controller 13, and adapted to dock with the existing positional tracking system. The existing positional tracking system is a tracker 4 or a handheld controller 5. The docking mechanism 2 is either a tracker docking mechanism 2a shown in FIG. 2 or a handheld controller docking mechanism 2b shown in FIG. 3, depending on the type of the existing positional tracking system.

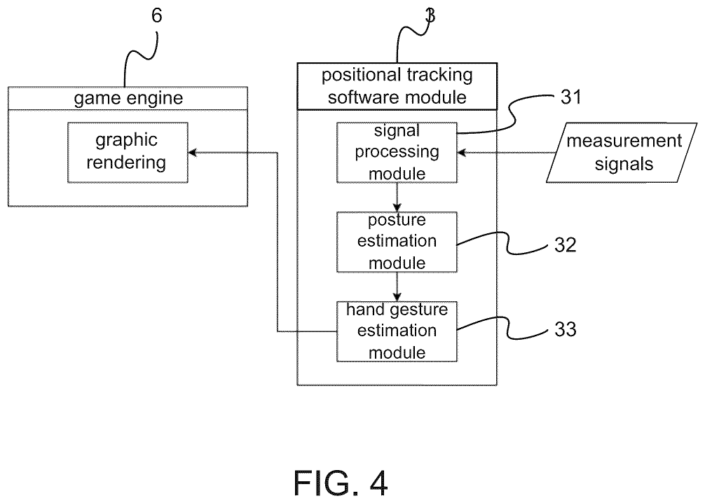

The positional tracking software module 3 and the tracking system hardware module 1 together form a tracking system. The positional tracking software module 3, whose structure is shown in FIG. 4, has a signal processing module 31 connected to the sensor modules 12, a posture estimation module 32 connected to the signal processing module 31, and a hand gesture estimation module 33 connected not only to the posture estimation module 32 but also to a game engine 6 to perform graphic rendering. Therefore, a brand new, novel tracking system and device integrating an existing positional tracking system and a docking mechanism are provided.

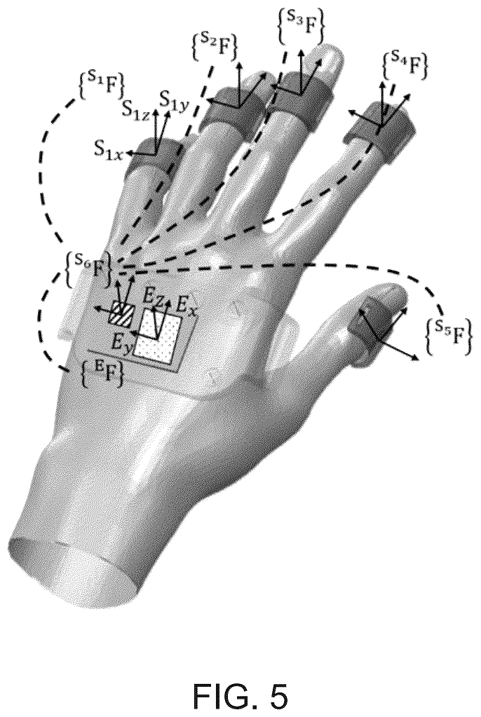

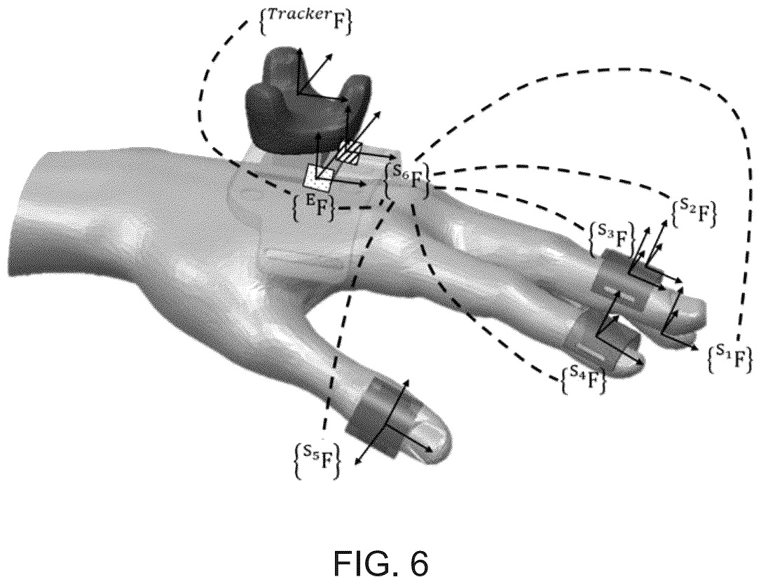

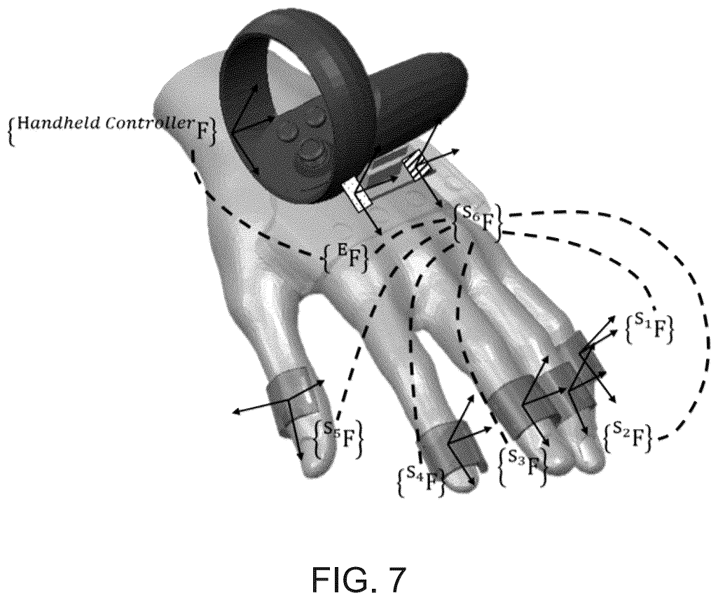

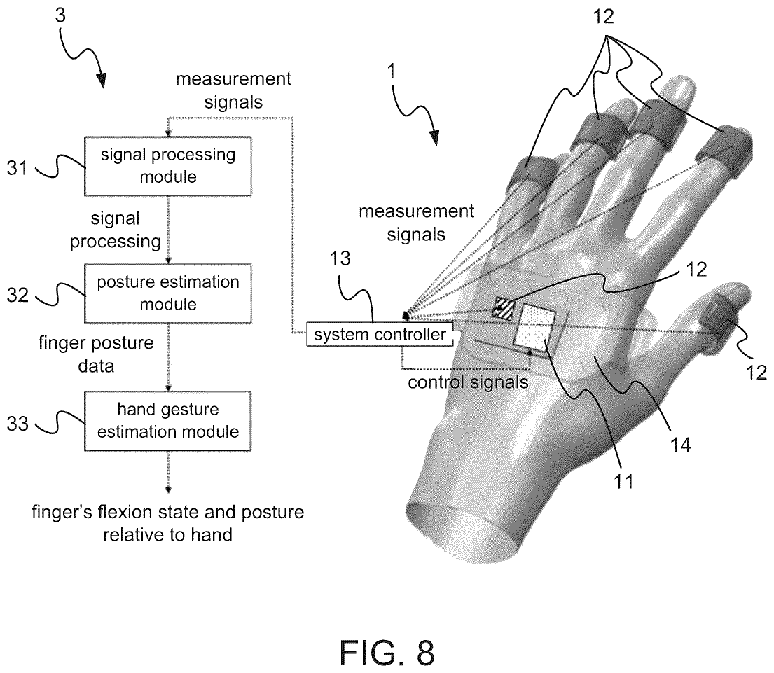

Regarding a tracking system and a device integrating an existing positional tracking system and a docking mechanism according to the disclosure, the coordinate transformation of the docking mechanism 2 not in use is shown in FIG. 5, and the coordinate transformation of the docking mechanism 2 in use is shown in FIGS. 6, 7. Referring to FIG. 6, there is shown a schematic view of coordinate transformation of the device having a tracker 4 and a tracker docking mechanism 2a according to the disclosure. Referring to FIG. 7, there is shown a schematic view of coordinate transformation of the device having a handheld controller 5 and a handheld controller docking mechanism 2b according to the disclosure. The hardware and software data transmission of the device are schematically shown in FIG. 8.

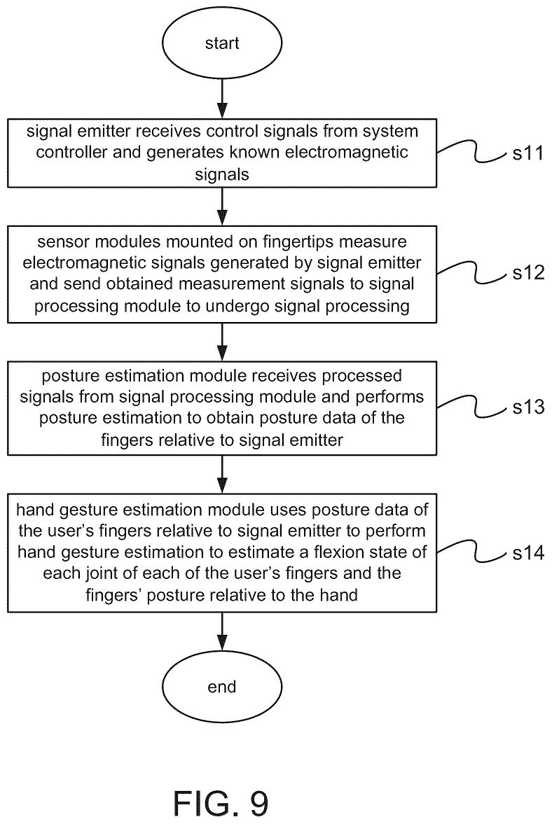

Referring to FIG. 9, there is shown a schematic view of the process flow of system operation of the device of the disclosure. As shown in the diagram, in step s11, the signal emitter 11 receives control signals from the system controller 13 and generates known electromagnetic signals. In step s12, when the user's fingers move relative to the signal emitter 11, the sensor modules 12 mounted on the user's fingertips measure electromagnetic signals generated by the signal emitter 11 and send obtained measurement signals to the signal processing module 31 to undergo signal processing. In step s13, the posture estimation module 32 receives processed signals and performs posture estimation to obtain posture data of the fingers relative to the signal emitter 11. In step s14, the hand gesture estimation module 33 uses posture data of the user's fingers relative to the signal emitter 11 to perform hand gesture estimation to estimate a flexion state of each joint of each of the user's fingers and the fingers' posture relative to the hand. With the docking mechanism 2 operating in conjunction with an existing third-party positional tracking system, a posture relation between the existing third-party positional tracking system and the tracking system is established with a known geometric design parameter of the docking mechanism, and absolute posture of the user's fingers in actual space is calculated according to the posture relation.

Therefore, the disclosure provides a tracking system and a device integrating an existing positional tracking system and a docking mechanism to capture a user's finger movement and send in real time and synchronously the user's finger movement to a computer. The docking mechanism is compatible with an existing third-party positional tracking system such that the device can operate in conjunction with existing, commercially-available positional tracking systems, for example, HTC VIVE Tracker, and Oculus Quest, and thus is applicable to an existing game engine.

In conclusion, the disclosure provides a tracking system and a device integrating an existing positional tracking system and a docking mechanism to effectively overcome drawbacks of the prior art and effectively capture a user's finger posture. With the docking mechanism operating in conjunction with an existing third-party positional tracking system, the absolute posture of the user's fingers in actual space can be captured. Therefore, the disclosure involves an inventive step and has high industrial applicability, thereby meeting patentability requirements.

The disclosure is disclosed above by preferred embodiments. The embodiments are illustrative of the disclosure but shall not be interpreted as restrictive of the scope of implementation of the disclosure. Hence, all simple equivalent variations and modifications made to the aforesaid embodiments according to the claims and detailed description of the disclosure shall be deemed falling within the scope of the claims of the disclosure.

What is claimed is:

1. A tracking system and a device integrating an existing positional tracking system and a docking mechanism, comprising:
a tracking system hardware module essentially having a signal emitter, multiple sensor modules and a system controller, the sensor modules being mounted on a user's fingertips and a dorsal side of the user's hand, wherein the signal emitter and the system controller are mounted on the dorsal side of the user's hand such that the signal emitter receives control signals from the system controller and generates known electromagnetic signals, and, when the user's fingers move relative to the signal emitter, the sensor modules mounted on the fingertips measure the electromagnetic signals generated by the signal emitter and output measurement signals thus obtained;
a docking mechanism mounted on the dorsal side of the user's hand and adapted to dock with the existing positional tracking system; and
a positional tracking software module forming the tracking system together with the tracking system hardware module and having a signal processing module connected to the sensor modules, a posture estimation module connected to the signal processing module, and a hand gesture estimation module connected to the posture estimation module, wherein the signal processing module receives the measurement signals from the sensor modules, performs signal processing on the measurement signals, and sends the processed measurement signals to the posture estimation module for calculating a posture of each of the sensor modules and a posture data of each of the user's fingers relative to the signal emitter such that the posture data is used by the hand gesture estimation module to estimate a flexion state of each joint of each of the user's fingers and the fingers' posture relative to the hand, wherein, with the docking mechanism operating in conjunction with an existing third-party positional tracking system, a posture relation between the existing third-party positional tracking system and the tracking system is established with a known geometric design parameter of the docking mechanism, and absolute posture of the user's fingers in actual space is calculated according to the posture relation.

2. The tracking system and a device integrating an existing positional tracking system and a docking mechanism according to claim 1, wherein the docking mechanism is either a tracker docking mechanism or a handheld controller docking mechanism, depending on the existing positional tracking system.
